(19) United States
(12) Patent Application Publication
(10) Pub. No.: US 2020/0369921 A1
(43) Pub. Date: Nov. 26, 2020

(54) ADHESIVE SHEET

(71) Applicant: 3M INNOVATIVE PROPERTIES COMPANY, SAINT PAUL, MN (US)

(72) Inventor: YOSHITERU KAKINUMA, TOKYO (JP)

(73) Assignee: 3M INNOVATIVE PROPERTIES COMPANY, SAINT PAUL, MN (US)

(21) Appl. No.: 16/957,844

(22) PCT Filed: Jan. 2, 2019
(86) PCT No.: PCT/IB2019/050022

§ 371 Date: Jun. 25, 2020

(30) Foreign Application Priority Data
Jan. 4, 2018 (JP) 2018-000205

(51) Int. Cl. C09J 7/21

(52) U.S. Cl. CPC C09J 7/21; C09J 2483/00

(57) ABSTRACT

The disclosed adhesive sheet that exhibits high anchoring performance and where separation between the substrate and the adhesive layer substantially does not occur when unwinding or re-peeling in actual applications. The adhesive sheet comprises a substrate including a heteroatom-containing polymer component at least at a portion of a surface a silicone adhesive layer that is in contact with the heteroatom-containing polymer component, wherein the heteroatom-containing polymer having, at a side chain, an N,N-substituted amino group or a heterocyclic group.

### TECHNICAL FIELD

The present disclosure relates to an adhesive sheet.

### BACKGROUND

Numerous types of adhesives such as acrylic-based, silicone-based, and natural rubber-based adhesives are known as adhesives can be used to make adhesive sheets. Crosslinked adhesives can be used, and as one crosslinking method, in some cases, radiation crosslinking such as electron beam crosslinking may be used.

### SUMMARY

Adhesive sheets are often provided in a roll form, namely as an adhesive tape. To unwind the tape, the adhesive layer is detached from a substrate and remains on an adjacent tape back surface. Furthermore, in a case where an adhesive sheet is temporarily affixed to skin or another adherend and then later detached, the substrate and adhesive layer can separate when detaching, and only the adhesive layer remains on the adherend.

The disclosed adhesive sheet that exhibits high anchoring performance (anchor effect) and in which separation between the substrate and the adhesive layer substantially does not occur when unwinding or re-peeling in actual applications.

In one embodiment, an adhesive sheet comprises: a substrate including a heteroatom-containing polymer component at least at a portion of a surface; and a silicone adhesive layer that is laminated so as to contact the heteroatom-containing polymer component; the heteroatom-containing polymer being a polymer having, at a side chain, an N,N-substituted amino group or a heterocyclic group.

The adhesive sheet exhibits excellent adherence, or in other words, high anchoring performance (anchor effect) between the silicone adhesive and the substrate, and in actual applications, separation between the substrate and the adhesive layer substantially does not occur when unwinding or re-peeling. Furthermore, the occurrence of stickiness is prevented at the substrate including a heteroatom-containing polymer component at least at a portion of the surface.

The heterocyclic group may be a heterocyclic group having a nitrogen atom as a heteroatom. An adhesive sheet having this type of configuration exhibits better anchoring performance with respect to one aspect.

A layer of the heteroatom-containing polymer component may be formed on the substrate, or the heteroatom-containing polymer component may be present internally and on the surface of the substrate. A fabric is useful as the substrate, and the silicone adhesive is preferably a crosslinked silicone adhesive.

### BRIEF DESCRIPTION OF DRAWINGS

FIG. 1 is a graph showing the results of examples.

FIG. 2 is a graph showing the results of examples.

### DETAILED DESCRIPTION

In one embodiment, an adhesive sheet comprises a substrate including a heteroatom-containing polymer component at least at a portion of a surface and a silicone adhesive layer in contact with the heteroatom-containing polymer component. The adhesive sheet may be shaped in the form of a sheet, and a tape-shaped adhesive sheet, namely an adhesive tape, is also included in adhesive sheets. The adhesive tape may be provided in an unwound shape.

With the adhesive sheet, the heteroatom-containing polymer component needs only to be formed at least at a portion of the surface of the substrate, and therefore cases in which the substrate is a film, for example, include forms such as (a) a form in which a layer made from the heteroatom-containing polymer component is formed on the entire surface of the substrate, (b) a form in which a layer made from the heteroatom-containing polymer component is formed on a portion of the surface, and (c) a form in which a heteroatom-containing polymer is contained in the material configuring the film-shaped substrate, and the heteroatom-containing polymer is exposed at a portion or at the entirety of the surface.

Cases in which the substrate is a fabric (the significance of fabric will be described below) include forms such as (d) a form with which the entire surface of the fabric is covered by a layer made from the heteroatom-containing polymer component, (e) a form with which a portion of the fabric is covered by a layer made from the heteroatom-containing polymer component, (f) a form in which a layer made from the heteroatom-containing polymer component is formed on a portion or the entirety of a surface of fibers, and a fabric is formed from the fibers thereof, and (g) a form in which at least some of a plurality of fibers are made from a heteroatom-containing polymer, and a fabric is formed from the fibers thereof. With fabrics, in one embodiment all of the gaps between fibers are filled with a heteroatom-containing polymer, in one embodiment some of the gaps between fibers are filled with a heteroatom-containing polymer, and in one embodiment the gaps between fibers are not filled with a heteroatom-containing polymer are possible.

Of the above-mentioned forms, (a), (b), (d) and (e) correspond to aspects in which a layer of a heteroatom-containing polymer component is formed on the substrate, and (c), (f) and (g) correspond to aspects in which the heteroatom-containing polymer component is present on the substrate surface and internally.

The heteroatom-containing polymer, a component that is present at least at a portion of the substrate surface, is a polymer containing a heteroatom as an atom configuring a side chain, and the side chain thereof has an N,N-substituted amino group or a heterocyclic group. Here, the matter of having an N,N-substituted amino group or a heterocyclic group at a side chain means that an N,N-substituted amino group or a heterocyclic group is bonded directly or through another group (divalent organic group, and the like) to the main chain. The side chain may have either or both of the N,N-substituted amino group and the heterocyclic group.

The N,N-substituted amino group (also refers to an N,N-disubstituted amino group) refers to a group for which two hydrogen atoms of an amino group (—NH₂) are substituted with another group. Here, the two hydrogen atoms of the amino group may be substituted with the same type of group or may be substituted with different types of groups.

Namely, the N,N-substituted amino group can be expressed by —NR¹R², and R¹ and R² may be the same group, or may be respectively different groups. R¹ and R² are each independently an alkyl group, an aryl group, or an aralkyl group, and as the alkyl group, an alkyl group having from 1 to 6 carbons is preferable, and an alkyl group having from 1 to 3 carbons is more preferable. Specific examples of R¹ and R² include a methyl group, an ethyl group, a propyl group, an n-butyl group, an n-pentyl group, an n-hexyl group, and a phenyl group. R¹ and R² are preferably a methyl group.

The heterocyclic group is a group derived from a heterocycle in which at least one of the atoms configuring the ring is a heteroatom, and typically is a group with which a carbon atom or a heteroatom configuring the heterocycle can be bonded to the main chain either directly or through another group. Here, the heterocycle may contain one or more types of heteroatoms that are the same or different in the same ring. In addition, the heterocycle may be a single ring or multiple rings, and in the case of multiple rings, a bicyclic type heterocycle or a tricyclic type heterocycle is preferable. The heterocycle may contain an unsaturated bond (unsaturated heterocycle) or may not contain an unsaturated bond (saturated heterocycle). The heterocycle may be an aromatic heterocycle (a pyridine ring or an imidazole ring, for example), or may be a non-aromatic heterocycle (a pyrrolidone ring, for example).

Each of the rings configuring the heterocycle may be a three-membered ring, a four-membered ring, a five-membered ring, a six-membered ring, a seven-membered ring, an eight-membered ring, a nine-membered ring or a ten-membered ring. A three-membered ring, four-membered ring, five-membered ring or six-membered ring is preferable, and a five-membered ring or a six-membered ring is more preferable. As the heterocycle, a monocyclic or bicyclic heterocycle having from 5 to 10 atoms configuring a ring is favorable, and a monocyclic heterocycle having from 5 or 6 atoms configuring the ring is particularly preferable. The number of heteroatoms presents in the same ring of a heterocycle can be from 1 to 3, and 1 or 2 is more preferable. Examples of heteroatoms include an oxygen atom, a nitrogen atom, and a sulfur atom, and of these, a nitrogen atom or a sulfur atom is preferable, and a nitrogen atom is more preferable. The heterocycle may have, as heteroatoms, two nitrogen atoms, or one nitrogen atom and one sulfur atom.

The heterocycle may be substituted with a substituent. The substituent includes a monovalent or multivalent group, and for example, includes an alkyl group having from 1 to 6 carbons and an oxo group (═O).

Examples of heterocycles include (1) an aziridine ring and an azirine ring as heterocycles that are three-membered rings having one nitrogen atom; (2) an oxirane ring and an oxirene ring as heterocycles that are three-membered rings having one oxygen atom; (3) a thiirane ring and a thiirene ring as heterocycles that are three-membered rings having one sulfur atom; (4) an azetidine ring and an azete ring as heterocycles that are four-membered rings having one nitrogen atom; (5) an oxetane ring as a heterocycle that is a four-membered ring having one oxygen atom; and (6) a thietane ring as a heterocycle that is a four-membered ring having one sulfur atom.

Other examples include (7) a pyrrolidine ring and an azole ring as heterocycles that are five-membered rings having one nitrogen atom; (8) pyrrolidone rings (2-pyrrolidone ring, and the like) as heterocycles that are five-membered rings having one nitrogen atom and one substituent; (9) an oxolane ring and an oxole ring as heterocycles that are five-membered rings having one oxygen atom; (10) a thiolane ring and a thiol ring as heterocycles that are five-membered rings having one sulfur atom; (11) an imidazole ring, a pyrazole ring, and an imidazoline ring as heterocycles that are five-membered rings having two nitrogen atoms; (12) a dioxolane ring as a heterocycle that is a five-membered ring having two oxygen atoms; (13) an oxazole ring and an isoxazole ring as heterocycles that are five-membered rings having one nitrogen atom and one oxygen atom; (14) a thiazole ring and an isothiazole ring as heterocycles that are five-membered rings having one nitrogen atom and one sulfur atom; (15) a triazole ring as a heterocycle that is a five-membered ring having three nitrogen atoms; (16) an oxadiazole ring as a heterocycle that is a five-membered ring having two nitrogen atoms and one oxygen atom; and (17) a tetrazole ring as a heterocycle that is a five-membered ring having four nitrogen atoms.

Further examples include (18) a piperidine ring and a pyridine ring as heterocycles that are six-membered rings having one nitrogen atom; (19) an oxane ring as a heterocycle that is a six-membered ring having one oxygen atom; (20) a thiane ring as a heterocycle that is a six-membered ring having one sulfur atom; (21) a pyrimidine ring, a pyrazine ring, a pyridazine ring, and a piperazine ring as heterocycles that are six-membered rings having two nitrogen atoms; (22) a dioxane ring as a heterocycle that is a six-membered ring having two oxygen atoms; (23) a morpholine ring as a heterocycle that is a six-membered ring having one nitrogen atoms and one oxygen atom; (24) a thiazine ring and a thiomorpholine ring as heterocycles that are six-membered rings having one nitrogen atom and one sulfur atom; and (25) a triazine ring as a heterocycle that is a six-membered ring having three nitrogen atoms.

Further examples include (26) an indole ring, isoindole ring, quinoline ring, and isoquinoline ring as bicyclic heterocycles having one nitrogen atom; (27) a chromene ring, isochromene ring, and benzofuran ring as bicyclic heterocycles having one oxygen atom; (28) a benzothiophene ring as a bicyclic heterocycle having one sulfur atom; (29) a benzoimidazole ring, a quinoxaline ring, a cinnoline ring, and an indazole ring as bicyclic heterocycles having two nitrogen atoms; (30) a benzotriazole ring as a bicyclic heterocycle having three nitrogen atoms; (31) a purine ring and a pteridine ring as bicyclic heterocycles having four nitrogen atoms; (32) an acridine ring and a carbazole ring as tricyclic heterocycles having one nitrogen atom; (33) a xanthene ring as a tricyclic heterocycle having one oxygen atom; and (34) a benzo-C-cinnoline ring as a tricyclic heterocycle having two oxygen atoms.

Examples of the heterocycle include aromatic heterocycles such as a pyridine ring, pyrimidine ring, pyridazine ring, pyrazine ring, triazine ring, pyrrole ring, imidazole ring, pyrazole ring, indole ring, indazole ring, furan ring, benzofuran ring, thiofuran ring, benzothiofuran ring, thiazole ring, isothiazole ring, oxazole ring, isooxazole ring, and oxadiazole ring, or non-aromatic heterocycles such as pyrrolidone rings (2-pyrrolidone ring, and the like), pyrrolidine ring, piperidine ring, piperazine ring, morpholine ring, and a thiomorpholine ring, and more preferably, the pyridine ring, imidazole ring, and pyrrolidone ring.

The heteroatom-containing polymer can be obtained, for example, through a vinyl polymerization reaction of a vinyl monomer (heteroatom-containing monomer) having an N,N-substituted amino group or a heterocyclic group at a side chain, or through a polycondensation reaction or polyaddition reaction of a compound having an N,N-substituted amino group or a heterocyclic group at a side chain. After the main chain is formed by vinyl polymerization, polycondensation, or polyaddition, an N,N-substituted amino group or a heterocyclic group may be introduced into a side chain. As the heteroatom-containing polymer, one that is obtained by a vinyl polymerization reaction is preferable, and in this case, the heteroatom-containing monomer and a monomer other than this (monomer not containing a heteroatom) may be copolymerized. Examples of the monomer not containing a heteroatom include compounds having an ethylenically unsaturated bond, such as (meth)acrylic acid, methacrylate, styrene, and vinyl acetate.

For cases in which the heteroatom-containing polymer is obtained by copolymerization of a heteroatom-containing monomer and a monomer not containing a heteroatom, the percentage of the heteroatom-containing monomer accounting for all monomers may be from 20 to 80 mol % or from 30 to 50 mol %.

The weight average molecular weight of the heteroatom-containing polymer may be 5000 or greater; 20000 or greater; or 70000 or greater. The upper limit of the weight average molecular weight of the heteroatom-containing polymer is not particularly limited. For cases in which the weight average molecular weight of the heteroatom-containing polymer is within the above-mentioned range, the occurrence of stickiness when the heteroatom-containing polymer component is formed at least on a portion of the substrate is further prevented. Since the occurrence of stickiness is prevented, the tape manufacturing and processability when handling or such are further improved, and the temporary storage stability of the substrate including the heteroatom-containing polymer component is further improved. The weight average molecular weight is a polystyrene standard equivalent value that is measured, for example, through gel permeation chromatography (GPC).

The substrate including a heteroatom-containing polymer component at the surface can be a film or fabric as described above but is not limited thereto. Fabric means a fabric formed into a thin sheet shape using a plurality of fibers, and fabrics are classified into textiles, knits, lace, felt, nonwoven fabrics, and paper according to the production method. The adhesive sheet is affixed to various types of adherends and used, but for a case in which the adhesive sheet is affixed to skin, the adhesive sheet is required to follow the movement of the skin and needs to be air permeable and moisture permeable. Therefore, in a case where the adhesive sheet is used in this type of application, use of a fabric as the substrate is suitable. For cases in which a fabric or the like is used as the substrate, the heteroatom-containing polymer component can be effectively fixed to the substrate surface. When a specific nonwoven fabric or the like is used as the substrate, a characteristic of hand-tearability can also be imparted to the adhesive sheet.

A textile is a cloth that is obtained by weaving a warp and a weft, and a knit means a knitted fabric that is obtained by creating a loop from one or a plurality of threads, and then hooking the next thread on that loop to create a new loop. Lace refers to a fabric that is made into an openwork cloth-like form with one or a plurality of threads, and felt means a sheet that is obtained by thinly compressing animal hair fibers or the like into a sheet shape. A nonwoven fabric is a sheet obtained by entangling fibers without weaving (excluding paper, felt and knits). Nonwoven fabrics include nonwoven fabrics configured from short fibers (namely, staples) (short fiber nonwoven fabrics), and nonwoven fabrics configured from long fibers (namely, filaments) (long fiber nonwoven fabrics). Examples of short fiber nonwoven fabrics include generally carded nonwoven fabrics, airlaid nonwoven fabrics, and wet-type nonwoven fabrics. Examples of long fiber nonwoven fabrics include generally spun bond nonwoven fabrics and spunlace nonwoven fabrics. Examples of interfiber bonding in short fiber nonwoven fabrics and long fiber nonwoven fabrics include heat, adhesive resin, and hydrogen bonding between fibers that is the same as the interfiber bonding of paper and the like. Staples ordinarily have a fiber length of several hundred mm or less, but are not limited thereto.

In a case where the substrate is a film, the thickness is preferably from 12 to 250 μm, and the film may be a single layer film or a multilayer film.

In a case where the substrate is a fabric, the basis weight is preferably from 10 to 300 g/m². The substrate may also be one that has been corona treated.

To form the heteroatom-containing polymer component on at least a portion of the surface of the substrate, a heteroatom-containing polymer (may be any of an organic solvent solution, an aqueous solution, an aqueous dispersion, or a molten substance) may be applied onto the substrate by a method such as coating, spraying, and melt extrusion casting. In addition, the substrate may be immersed in an organic solvent solution, an aqueous solution, an aqueous dispersion or a molten substance of a heteroatom-containing polymer. When the substrate itself contains a heteroatom-containing polymer, the substrate may be manufactured by mixing the polymer and the like, which configure the substrate, with the heteroatom-containing polymer.

As described above, a nonwoven fabric can be used as the substrate, and for cases in which the substrate is a nonwoven fabric, the heteroatom-containing polymer component can be formed at least at a portion of the surface of the substrate through the above-described methods, and a method like that described below.

Nonwoven fabrics can be manufactured using a melt blow device provided with an extruder, an extrusion chamber for molten thermoplastic material, and a melt blow die having a die orifice through which the molten thermoplastic material is extruded and a gas orifice through which gas (hot air, and the like) is sprayed at a high speed. In this case, molten resin is extruded from the melt blow die to form melt blown fibers, the melt blown fibers are sprayed onto a rotating drum, the fibers are accumulated on the drum surface, and thereby a nonwoven fabric is obtained.

In this case, a plurality of melt blow dies can be used, a heteroatom-containing polymer can be extruded from one of the plurality of melt blow dies to form heteroatom-containing polymer fibers, which can then be entangled with other fibers, and thereby the heteroatom-containing polymer component can be formed at least at a portion of the surface of the substrate. Furthermore, melt blow dies that can form fibers having a core-sheath structure may be used with the sheath being made of the heteroatom-containing polymer component.

A substrate including a heteroatom-containing polymer component at least on a portion of the surface is obtained by the above-described method, but a silicone adhesive may be laminated so as to contact this heteroatom-containing polymer component, thereby forming a silicone adhesive layer, and a targeted adhesive sheet can thereby be obtained.

The silicone adhesive is an adhesive containing a component having a polyorganosiloxane skeleton, and as the component having a polyorganosiloxane skeleton, unmodified silicone (straight silicone), modified silicone and a combination thereof can be used.

Here, unmodified silicone refers to dimethyl silicone (silicone in which the polysiloxane side chains and terminals are all methyl groups), and modified silicone refers to a silicone for which at least some of the methyl groups are substituted with other groups or atoms. The other groups or atoms can be categorized into reactive (reactive groups) and non-reactive (non-reactive groups), and an example of a modified silicone having a non-reactive group is methylphenyl silicone (in which some of the side chains of dimethyl silicone are phenyl groups), and an example of a modified silicone having reactive atoms is methyl hydrogen silicone (in which some of the side chains of dimethyl silicone are hydrogen atoms).

Modified silicone may have atoms or a group besides methyl at the side chains and/or terminals. Of these, reactive groups include an amino group, an epoxy group, a carbinol group, a vinyl group, a (meth)acryloyl group, a polyether group, a mercapto group, a carboxyl group, a phenol group, and a hydroxyl group, and an example of the reactive atom includes the above-described hydrogen atom (hydrogen modified). Examples of non-reactive groups include the above-described phenyl group, a long-chain alkyl group, and an aralkyl groups.

Considering the holding force and adhesive force, the silicone adhesive is preferably a crosslinked silicone adhesive. In this case, a component having a crosslinked structure is used as the component having a polyorganosiloxane skeleton. For example, a crosslinked structure can be introduced by using a modified silicone having a first reactive group and a silicone having a second reactive group, and chemically bonding the first and second reactive groups. An example of this is a case with which a silicone having a hydrogen atom at a side chain and/or terminal, and a silicone having a vinyl group at a side chain and/or terminal are bonded through a hydrosilylation reaction. A reaction catalyst may be used for a case in which a crosslinked structure is introduced using a reactive group in this manner.

The crosslinked structure can also be introduced through radiation crosslinking. Examples of radiation crosslinking include electron beam crosslinking and γ-beam crosslinking. In the case of introduction through radiation crosslinking, the silicone is not required to have a reactive group, and a reaction catalyst for crosslinking is not necessary.

To increase the adhesiveness of the silicone adhesive, the silicone adhesive may include a silicate adhesiveness imparting agent. As the silicate adhesiveness imparting agent, one configured from at least one of an M-unit (monovalent R₃SiO_{1/2} unit), a D-unit (divalent R₂SiO_{2/2} unit), a T-unit (trivalent RSiO_{3/2} unit) and a Q-unit (tetravalent SiO_{4/2} unit) is useful. R represents an alkyl group or aryl group, and a methyl group is preferable.

The silicate adhesiveness imparting agent are particularly preferably an MQ resin made from an M-unit and a Q-unit; an MQD resin made from an M-unit, a Q-unit, and a D-unit; and an MQT resin made from an M-unit, a Q-unit, and a T-unit. The number average molecular weight of the silicate adhesiveness imparting agent is typically from 100 to 50000.

In addition to the silicate adhesiveness imparting agent, the silicone adhesive may also include silicones (for example, oil, fluid, and gum, elastomer) of different molecular weights, a stabilizer, an antioxidant, a filler, and the like.

The adhesive sheet can be produced by fabricating a substrate including a heteroatom-containing polymer component at least on a portion of the surface by the above-described method, applying a silicone adhesive so as to contact the heteroatom-containing polymer component, volatilizing the solvent and the like as necessary, and performing radiation crosslinking or chemical crosslinking according to the type of silicone adhesive. The thickness of the silicone adhesive layer is preferably from to 10 to 1000 μm.

Although specific embodiments have been shown and described herein, it is understood that these embodiments are merely illustrative of the many possible specific arrangements that can be devised in application of the principles of the invention. Numerous and varied other arrangements can be devised in accordance with these principles by those of skill in the art without departing from the spirit and scope of the invention. The scope of the present invention should not be limited to the structures described in this application, but only by the structures described by the language of the claims and the equivalents of those structures.

### EXAMPLES

Below are examples and comparative examples. The following polymers were prepared. Polymers 2 to 4 were respectively prepared on the basis of Preparation Examples 1 to 3.

Polymer 1: Pyratex (trade name) (butadiene-styrene-vinylpyridine copolymer, Tg: −55° C., from Nippon A&L Inc.)

Polymer 2: dimethylamino ethyl acrylate-methyl acrylate copolymer (prepared based on Preparation Example 1)

Polymer 3: 1-vinylimidazole-methyl acrylate copolymer (prepared based on Preparation Example 2)

Polymer 4: 1-vinyl-2-pyrrolidine-methyl acrylate copolymer (prepared based on Preparation Example 3)

Polymer 5: Nalster SR 140 (trade name) (styrene-butadiene rubber, Tg: −12° C., from Nippon A&L Inc.)

Polymer 6: Nalster SR 119 (trade name) (styrene-butadiene rubber, Tg: −35° C., from Nippon A&L Inc.)

Polymer 7: MR173 (trade name) (butadiene-acrylonitrile copolymer, Tg: −20° C., from Nippon A&L Inc.)

Polymer 8: NK220 (trade name) (butadiene-acrylonitrile copolymer, Tg: −35° C., from Nippon A&L Inc.)

Polymer 9: Polyment NK350 (trade name) (aminoethylated acrylic polymer, from Nippon Shokubai Co., Ltd.)

### Preparation Example 1

10 parts by mass of dimethylamino ethyl acrylate (from Wako Pure Chemical Corporation), 90 parts by mass of methylacrylate (from Wako Pure Chemical Corporation), and 0.04 parts by mass of 2, 2′-azobis(2,4-dimethylvaleronitrile) (from Wako Pure Chemical Corporation) were uniformly stirred in 80 parts by mass of ethyl acetate (from Wako Pure Chemical Corporation), and subsequently copolymerized for 24 hours at 50° C. to thereby prepare a solution containing the polymer 2.

### Preparation Example 2

15 parts by mass of 1-vinylimidazole (from Wako Pure Chemical Corporation), 85 parts by mass of methylacrylate (from Wako Pure Chemical Corporation), and 0.04 parts by mass of 2, 2′-azobis(2,4-dimethylvaleronitrile) (from Wako Pure Chemical Corporation) were uniformly stirred in in a mixed solvent of 40 parts by mass of ethyl acetate and 40 parts by mass of methyl ethyl ketone (MEK, from Wako Pure Chemical Corporation), and subsequently copolymerized for 24 hours at 50° C. to thereby prepare a solution containing the polymer 3.

### Preparation Example 3

15 parts by mass of 1-vinyl-2-pyrrolidine (from Wako Pure Chemical Corporation), 85 parts by mass of methylacrylate (from Wako Pure Chemical Corporation), and 0.04 parts by mass of 2, 2′-azobis(2,4-dimethylvaleronitrile) (from Wako Pure Chemical Corporation) were uniformly stirred in a mixed solvent of 40 parts by mass of ethyl acetate and 40 parts by mass of MEK, and subsequently copolymerized for 24 hours at 50° C. to thereby prepare a solution containing the polymer 4.

Solutions containing any of the polymers 1 to 9 to which the concentration of the nonvolatile portion had been adjusted with water or a solvent were used for application to the below-described substrates.

### Adhesive Sheet Preparation

### Example 1

A solution containing the polymer 1 with the concentration of the nonvolatile portion adjusted to 5 mass % was uniformly coated onto a polyester/rayon nonwoven fabric substrate (from 3M) using a wire bar No. 10. After being coated, the substrate was fully dried in a 95° C. oven, and a substrate including the above-mentioned polymer component at least at a portion of the surface was obtained.

A silicone-based adhesive composition prepared by the below-described method was uniformly coated at an amount of 50 g/m² onto the substrate including the polymer component. The substrate including the polymer component onto which the silicone-based adhesive composition was applied was irradiated with an electron beam, after which the adhesive surface was covered with a fluorosilicone liner (trade name: MU, from Fujico Co., Ltd.) to thereby fabricate the adhesive sheet of Example 1. The electron beam irradiation was performed under a condition of 4.0 Mrad (210 keV) using an electron beam generating device (PCT, Davenport, Iowa). The silicone-based adhesive composition was prepared by the following method. Namely, polydimethyl siloxane (trade name: TSF451 AK 1000000 cs, from Momentive Performance Materials Japan, LLC) and an MQ resin (trade name: MQ803TF, from Wacker Chemie AG) were mixed at a weight ratio (polydimethyl siloxane/MQ resin) of 77/23, and a silicone-based adhesive composition was thereby prepared.

### Example 2

An adhesive sheet of Example 2 was fabricated in the same manner as Example 1 with the exception that a solution containing the polymer 1 with the concentration of the nonvolatile portion adjusted to 10 mass % was used.

### Example 3

An adhesive sheet of Example 3 was fabricated in the same manner as Example 1 with the exception that a solution containing the polymer 1 with the concentration of the nonvolatile portion adjusted to 40 mass % was used.

### Example 4

An adhesive sheet of Example 4 was fabricated in the same manner as Example 1 with the exception that a solution containing the polymer 2 with the concentration of the nonvolatile portion adjusted to 10 mass % was used.

### Example 5

An adhesive sheet of Example 5 was fabricated in the same manner as Example 1 with the exception that a solution containing the polymer 3 with the concentration of the nonvolatile portion adjusted to 10 mass % was used.

### Example 6

An adhesive sheet of Example 6 was fabricated in the same manner as Example 1 with the exception that a solution containing the polymer 4 with the concentration of the nonvolatile portion adjusted to 10 mass % was used.

### Comparative Example 1

An adhesive sheet of Comparative Example 1 was fabricated in the same manner as Example 1 with the exception that the substrate was used as is without being coated with a solution containing the Polymer 1.

### Comparative Example 2

An adhesive sheet of Comparative Example 2 was fabricated in the same manner as Example 1 with the exception that a solution containing the polymer 5 with the concentration of the nonvolatile portion adjusted to 40 mass % was used.

### Comparative Example 3

An adhesive sheet of Comparative Example 3 was fabricated in the same manner as Example 1 with the exception that a solution containing the polymer 6 with the concentration of the nonvolatile portion adjusted to 40 mass % was used.

### Comparative Example 4

An adhesive sheet of Comparative Example 4 was fabricated in the same manner as Example 1 with the exception that a solution containing the polymer 7 with the concentration of the nonvolatile portion adjusted to 40 mass % was used.

### Comparative Example 5

An adhesive sheet of Comparative Example 5 was fabricated in the same manner as Example 1 with the exception that a solution containing the polymer 8 with the concentration of the nonvolatile portion adjusted to 40 mass % was used.

### Comparative Example 6

An adhesive sheet of Comparative Example 6 was fabricated in the same manner as Example 1 with the exception that a solution containing the polymer 9 with the concentration of the nonvolatile portion adjusted to 5 mass % was used.

### Comparative Example 7

An adhesive sheet of Comparative Example 7 was fabricated in the same manner as Example 1 with the exception that a solution containing the polymer 9 with the concentration of the nonvolatile portion adjusted to 10 mass % was used.

### Example 7

An adhesive sheet of Example 7 was fabricated in the same manner as Example 2 with the exception that a soft polyvinyl chloride was used as the substrate.

### Comparative Example 8

An adhesive sheet of Comparative Example 8 was fabricated in the same manner as Comparative Example 1 with the exception that a soft polyvinyl chloride was used as the substrate.

### Anchoring Performance (Interfacial Adhesive Strength)

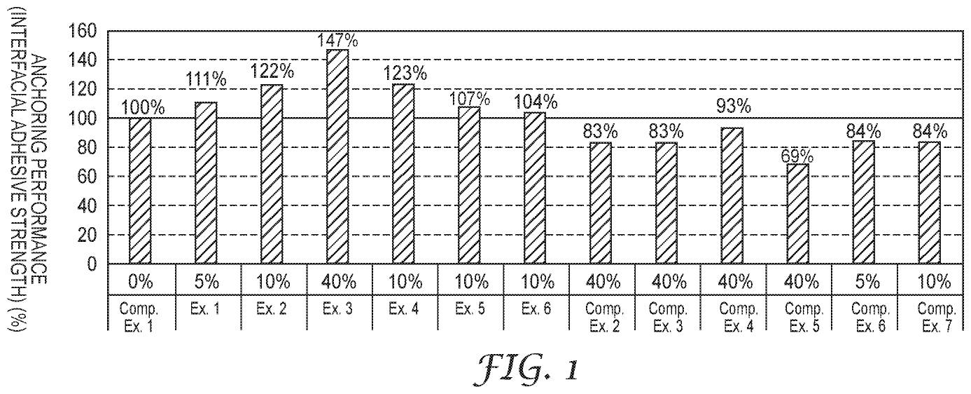

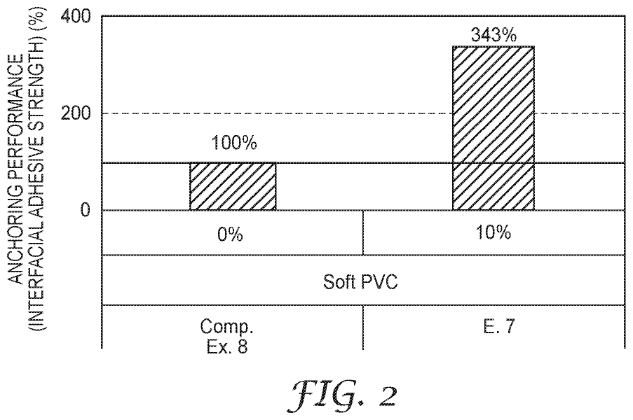

The anchoring performance was evaluated by measuring the interfacial adhesive strength between the adhesive and the substrate. First, the adhesive sheets of the examples and comparative examples were cut to 25 mm×70 mm, and a tab was created in each sheet by cutting inward a 25 mm×around 5 to 10 mm portion of the adhesive surface from the end. Next, the adhesive surface of a silicone tape (No. 8510, from 3M), and the adhesive surface of an adhesive sheet of an example or comparative example were adhered, and pressure bonded using a 2 kg roller at a speed of 5 mm/second. The substrate side of the adhesive sheet was fixed to a flat surface with double-sided tape or the like, and the stress (interfacial adhesive strength) when the silicone tape was peeled off at an angle of 180° and a speed of 300 mm/minute was measured and recorded. FIGS. 1 and 2 show the results of the interfacial adhesive strength of each of the examples and comparative examples based on the interfacial adhesive strength of each of the adhesive sheets of Comparative Examples 1 and 8 being 100%.

As shown in FIG. 1, for cases in which the substrate was a nonwoven fabric, the adhesive sheets of Examples 1 to 6 excelled in anchoring performance (in comparison to Comparative Examples 1 to 7). As shown in FIG. 2, similar to the cases in which the substrate was a nonwoven fabric, the results show that even in a case soft polyvinyl chloride was used, the adhesive sheets of the examples excelled in anchoring performance.

### Stickiness Evaluation

Substrates including a polymer component at least at a portion of the surface were obtained in the same manner as with the methods of Examples 1 to 6 with the exception of using, as the substrate, a polyethylene terephthalate (PET) film (Emblet S-38 polyester film from Unitika Ltd.) having a matte surface. In the stickiness evaluation, solutions respectively containing the above-mentioned polymers (polymer components) were coated onto the matte surface of the PET film.

Immediately after the substrates (substrate films) having the polymer components were removed from the oven, the substrates were positioned so that the surface onto which the polymer component was coated was oriented upward, and an untreated PET film was stacked thereon and pressure bonded (conditions: 2 kg roller, 50 mm/s per round trip). After pressure bonding, the untreated PET film was quickly peeled off from the substrate film by hand, and the transfer or lack of transfer of the polymer component to the untreated PET film was confirmed.

Cases to which the polymer component was not transferred to the untreated PET film were evaluated as preventing stickiness, and cases to which the polymer component was transferred were evaluated as being sticky. As a result, it was confirmed that all of the substrates having the prepared polymer component (heteroatom-containing polymer component) exhibited the prevention of stickiness.

1. An adhesive sheet comprising:
a substrate including a heteroatom-containing polymer component at least at a portion of a surface; and
a silicone adhesive layer in contact with the heteroatom-containing polymer component;
the heteroatom-containing polymer having, at a side chain, an N,N-substituted amino group or a heterocyclic group.

2. The adhesive sheet according to claim 1, wherein the heterocyclic group has a nitrogen atom as a heteroatom.

3. The adhesive sheet according to claim 1, wherein a layer of the heteroatom-containing polymer component is formed on the substrate.

4. The adhesive sheet according to claim 1, wherein the heteroatom-containing polymer component is present on the surface of the substrate and internally.

5. The adhesive sheet according to claim 1, wherein the substrate is a fabric.

6. The adhesive sheet according to claim 1, wherein the silicone adhesive is a crosslinked silicone adhesive.

7. The adhesive sheet according to claim 1, wherein the N,N-substituted amino group is —NR¹R², where in and R¹ and R² may be the same group, or may be respectively different groups.

8. The adhesive sheet of claim 7, wherein R¹ and R² are each independently an alkyl group, an aryl group, or an aralkyl group

9. The adhesive sheet of claim 1, wherein the heterocyclic group is derived from a heterocycle in which at least one of the atoms configuring the ring is a heteroatom, that are the same or different in the same ring.

10. The adhesive sheet of claim 1, wherein heterocycle comprises multiple rings of a bicyclic type heterocycle or a tricyclic type heterocycle.
